(19) United States
(12) Patent Application Publication
(10) Pub. No.: US 2025/0031642 A1
(43) Pub. Date: Jan. 30, 2025

(54) INDOOR SYSTEMS FOR MAKING SELF-SUFFICIENT GREEN WALLS AND PROCESSES FOR GROWING THE GREEN WALLS

(71) Applicant: GREEN BEING SOCIETA' BENEFIT A RESPONSABILITA' LIMITATA, Milano (MI) (IT)

(72) Inventors: Roberto ZILIANI, Roma (RM) (IT); Roberto Maurizio PAURA, Roma (RM) (IT); Renato REGGIANI, Roma (RM) (IT)

(21) Appl. No.: 18/717,779

(22) PCT Filed: Dec. 9, 2022
(86) PCT No.: PCT/IB2022/061965

§ 371 Date: Jun. 7, 2024

(30) Foreign Application Priority Data
Dec. 10, 2021 (IT) 102021000031091
Oct. 3, 2022 (IT) 102022000020289

(51) Int. Cl. A01G 31/06; A01G 7/04

(52) U.S. Cl. CPC A01G 31/06; A01G 7/045

(57) ABSTRACT

An indoor system for making self-sufficient green walls may include: a load-bearing structure including one or more growing receptacles, wherein each of the one or more growing receptacles includes a growing medium configured to contain, support, and/or feed roots of at least one plant; a feeding system configured to provide water, fertilizers, and/or other nutrients to the at least one plant; a photostimulation system including one or more light sources configured to stimulate photosynthesis processes in the at least one plant; and a control system configured to automatically control the feeding system and/or the photostimulation system based on detection of one or more operating variables of one or more of the feeding system, the photostimulation system, and one or more physical/chemical quantities of the at least one plant and/or an environment surrounding the at least one plant.

The present invention concerns an improved indoor system for making self-sufficient green walls, and a growing process for making and maintaining green walls for covering and embellishing walls and other interior walls of buildings such as for example homes, offices, business centres, underground, railway or other public transport stations, hospitals, factories, in order to make the environment more user-friendly.

### BACKGROUND ART

The physical and psychological benefits of plants on people have long been well known, in particular the benefits of plants in enclosed environments such as homes, workplaces or public transport stations.

In fact, decorating enclosed environments with plants on the one hand is known to have beneficial effects on the mood, reduces stress—measurable for example through a lower secretion of cortisol—and in general improves the mental well-being of people using the environment.

On the other hand, it is also known that plants purify the often stale air of enclosed environments, reducing the content of both carbon dioxide and other pollutants such as formaldehyde, limonene, toluene and the other so-called Volatile Organic Compounds (VOCs), which are often present in residential buildings because they are released by cosmetic products or deodorants, heating devices, detergents, soaps and other hygiene products, glues, adhesives, solvents, paints, dry-cleaned clothes or clothes recently collected from laundries, cigarette smoke, printers, photocopiers and other work tools, building materials and furnishings such as furniture, carpets, upholstery, wall paints.

Recent studies have confirmed and quantified the reflections of these benefits, both physical and mental, on work activities, which result in a reduction in absenteeism and turnover of staff, in an increase in productivity—estimated by some to be around 12%—in concentration and creativity, in a reduction in blood pressure, a biostimulation of the immune system, and a reduction of the symptoms of discomfort and disturbances at work by around 23%.

It is also commonly believed that the presence of plants in homes and workplaces generally reduces mental disorders.

These benefits are even more appreciable when one considers that the percentage of time people on average spend in enclosed environments has been steadily increasing over the past decades.

Currently, 85% of the inhabitants of the world's major cities spend more than 85% of their time enclosed in buildings or vehicles.

Due to the ongoing climate changes, the percentage is expected to be soon around 95-97%.

On the other hand, it is well known that the care of house plants and those in general in enclosed environments requires a lot of time, manual labour and experience, which have so far severely limited their presence in enclosed environments, in particular those intended for many people and in any case not specifically of a living type, and consequently the spread of the so-called “vertical gardens” or “green walls”, which would be supposed to cover large wall surfaces of enclosed environments. The need for maintenance and other operations, in order to be able to keep the system “green”, has so far limited its use to luxury or in any case very exclusive buildings.

Another factor that has so far limited the spread of green walls and vertical gardens in enclosed environments is the difficulty of supplying them with the necessary irrigation water: since it is impractical to permanently connect a green wall to a water network—for example to a household tap—via a pipe, hence, in current solutions, it must be periodically watered or in any case supplied with water, with the risk of plants dying or seriously decaying as a result of prolonged and often unavoidable failure to supply the necessary water.

Added to this is the problem related to the fact that these indoor green walls should ensure the necessary lighting to plants for their natural cycle, such as for example the chlorophyll synthesis, a necessity that limits their use considerably, especially prevents their use in enclosed, and very large, environments, or for example those underground, such as underground stations and the like.

On the other hand, the advantages of covering walls with plants are manifold: their large surfaces that in closed environments constitute the most visible architectural element, which is very often currently unattractive, when not dingy, can be greatly embellished, kept cleaner and transformed into large oxygen-producing green lungs as well as it can thermally insulate living spaces, taking up much less floor space than plants grown in traditional pots resting on floors or furniture.

An object of the present invention is to provide an indoor system for making self-sufficient green walls, and a growing process, which enable flora-based decorations, such as for example green walls and vertical gardens, to be more easily and conveniently made and maintained in enclosed environments, thereby making it possible to more easily achieve the advantages that such decorations offer, particularly in enclosed environments.

### SUMMARY OF THE INVENTION

This object is achieved, in a first aspect of the present invention, with an improved indoor system for making self-sufficient green walls having the features according to claim 1.

Other features of the system are described in the dependent claims.

In a particular embodiment of such an indoor system (1, 1′, 1″), said total reflectance value refers to any light radiation having a wavelength between 400-700 nm.

In a particular embodiment of such an indoor system (1, 1′, 1″), the control system (17) is configured for controlling the feeding system (9) and/or the photostimulation system (11) based on the detections of the carbon dioxide sensor (170).

In a particular embodiment of such an indoor system (1, 1′, 1″), the one or more light sources (13) are configured for emitting an electromagnetic radiation with a wavelength from 450-660 nm.

In a particular embodiment of such an indoor system (1, 1′, 1″), the growing medium (7) contains one or more of the following materials: perlite, expanded clay, volcanic lapillus, pumice, zeolite.

In a particular embodiment the indoor system (1, 1′, 1″) is configured for drawing in within the load-bearing structure (3, 3′) through the suction port (556) of the one or more growing receptacles (5, 5′) the air of the outside environment.

In a particular embodiment the indoor system (1, 1′, 1″) is configured for drawing in within the load-bearing structure (3, 3′) through the growing medium (7) contained in the one or more growing receptacles (5, 5′).

In a particular embodiment the indoor system (1, 1′, 1″) comprises a pneumatic vacuum generator (25) configured for producing within the load-bearing structure (3, 3′) a pneumatic vacuum because of which it draws in air from the outside environment.

In a particular embodiment, such a system comprises a supply system (15) configured for supplying electromagnetic, thermal, chemical and/or mechanical energy to the feeding system (9) and/or the photostimulation system (11) allowing the operation thereof, and the supply system (15) comprises one or more of the following elements: a photovoltaic panel (150), a connection to an external public or local electricity distribution network, a wind or hydraulic power generator, a generator unit comprising in turn an electric power generator and an internal combustion engine which is configured for operating the electric power generator, a fuel cell, a bioreactor.

In a particular embodiment of such a system, the photostimulation system (11) comprises one or more of the following elements: at least one light emitting diode lamp (13), and/or at least one incandescent lamp, a discharge lamp, and/or at least one lamp capable of emitting a light spectrum suitable for photostimulation for each kilogram of mass of said at least one plant (8) that it is whished to grow/keep alive through the growing system (1).

In a particular embodiment of such a system, the load-bearing structure (3, 3′) is configured for supporting at least part of the aerial part of said at least one plant by forming or comprising one or more of the following substructures: a panel or other substantially vertical wall, a lattice, a mesh, grid or grate, a pole, a pergola, a trellis, a floor, a ceiling, a vault.

In a particular embodiment of such a system, the load-bearing structure (3, 3′) is of modular type and is composed of a plurality of prefabricated modular modules (30) which are configured for being assembled together.

In a particular embodiment of such a system, one or more of the following elements, and possibly all of them, are fixed to the load-bearing structure (3, 3′) and possibly to one or more of the modular modules (30) that eventually make it up: the feeding system (9), the photostimulation system (11), the supply system (15), the control system (17).

In a particular embodiment of such a system, the feeding system (9) comprises one or more of the following elements: an irrigation system configured for supplying water or aqueous solutions to the one or more plants, a configured fertilisation system for providing fertiliser, soil improver or other fertilisers or other nutrients to the at least one plant (8).

In a particular embodiment of such a system, the feeding system (9) comprises a water generator (90) configured for obtaining liquid water from the atmospheric humidity.

In a particular embodiment of such a system, the water generator (90) comprises at least one Peltier cell in turn comprising a hot plate and a cold plate, and the water generator (90) is configured for condensing the atmospheric humidity on the cold plate and/or on a humidity condenser cooled by the cold plate.

In a particular embodiment of such a system, the photostimulation system is configured for providing at least half of the energy that the at least one plant needs in a predetermined time interval to implement its photosynthesis processes and at least survive, wherein the predetermined time interval can be for example one second, in one minute, in one hour, day, week, month, quarter, year or throughout the life of the at least one plant.

In a particular embodiment of such a system, the supply system is configured for providing at least one third of the energy absorbed in a predetermined time interval, by the feeding system (9) and/or by the photostimulation system (11) allowing its operation, wherein the predetermined time interval can be for example one second, in one minute, in one hour, day, week, month, quarter, year or throughout the life of the at least one plant.

In a second aspect of the invention, this object is achieved with a green wall having the features according to claim 13. In a third aspect thereof the present invention relates to a building comprising an indoor system having the features according to claim 14.

In a particular embodiment, said building includes at least one room (21) containing the system (1) and said one or more plants (8) fed by it and/or resting on the load-bearing structure thereof (3, 3′).

In a fourth aspect thereof the present invention relates to a process according to claim 15.

In a particular embodiment thereof, such a process comprises the operation of growing or otherwise keeping alive the at least one plant (8) via the growing system in an enclosed environment such as for example: a room (21), corridor, hall or other internal room of a building such as for example a railway station, an underground station, a bus station, a home, an office, a laboratory, a workshop, a conference room, a museum, a theatre, a tunnel, a hospital, a restaurant, a canteen, a hotel.

The present invention will now be described, by way of non-limiting illustration, according to the preferred embodiments thereof, with particular reference to the figures of the accompanying drawings, wherein:

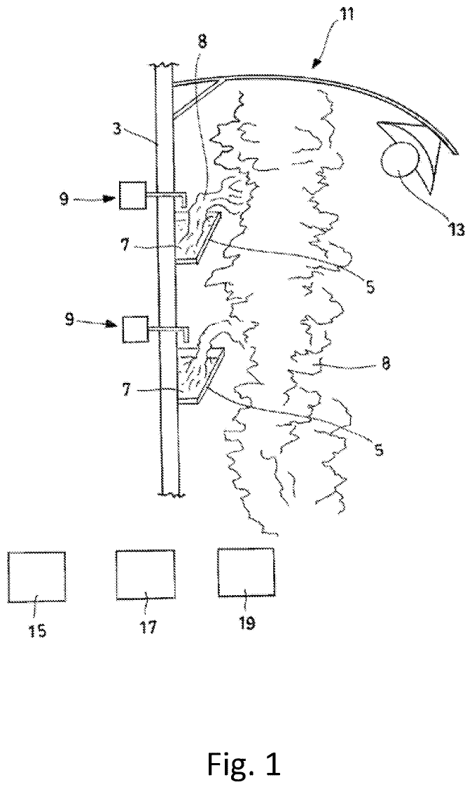

FIG. 1 shows a side view, partially in section, of a growing system according to a first particular embodiment of the present invention;

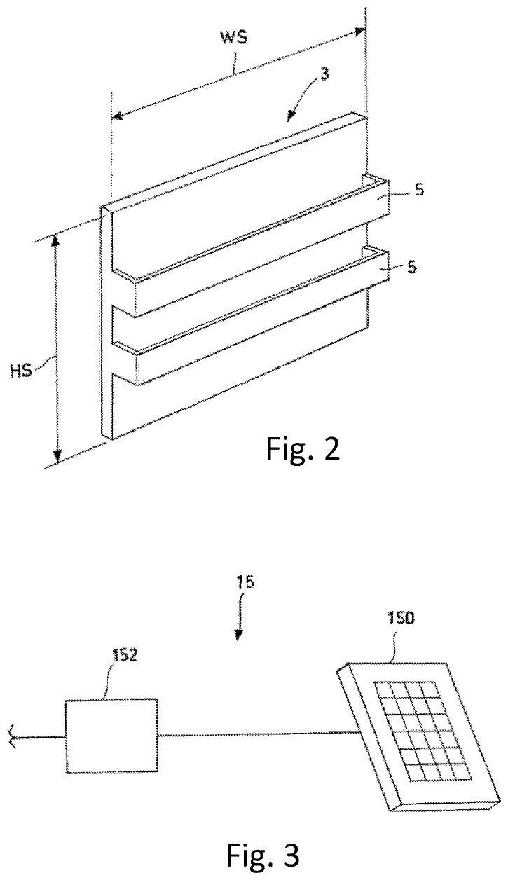

FIG. 2 shows a perspective view of the load-bearing structure of the growing system of FIG. 1;

FIG. 3 shows a functional diagram of part of the supply system of the growing system of FIG. 1;

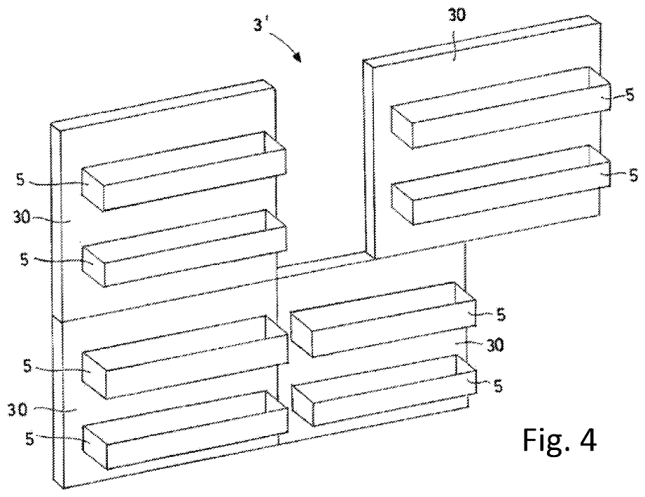

FIG. 4 shows a perspective view of the load-bearing structure of a growing system according to a second particular embodiment of the present invention;

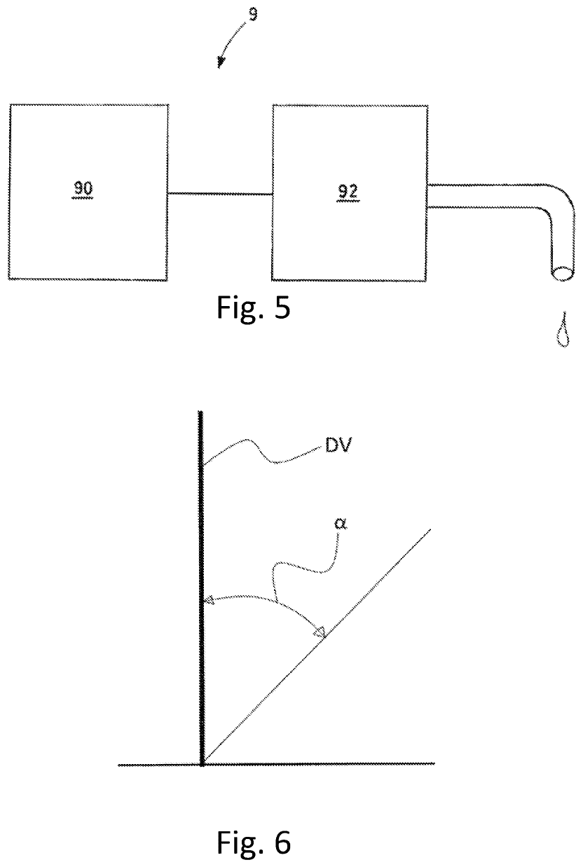

FIG. 5 shows a functional diagram of part of the feeding system of the growing system of FIG. 1;

FIG. 6 shows an explanatory image of the meaning of “substantially vertical”; and

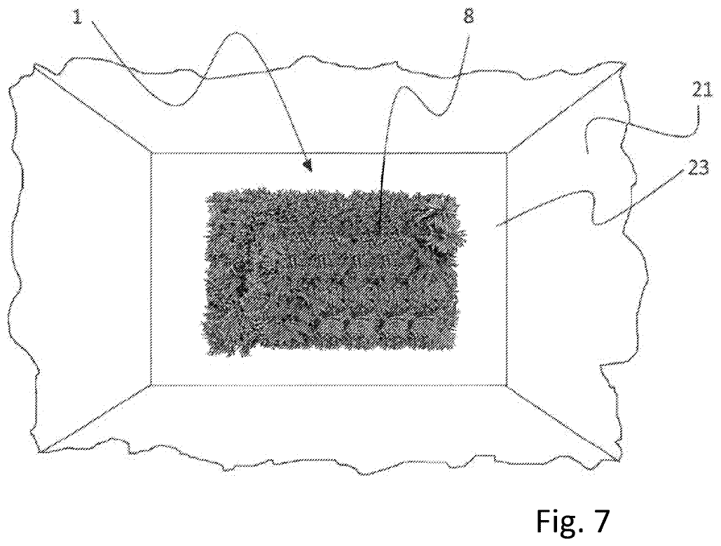

FIG. 7 shows a partial view of a building containing the growing system of FIG. 1;

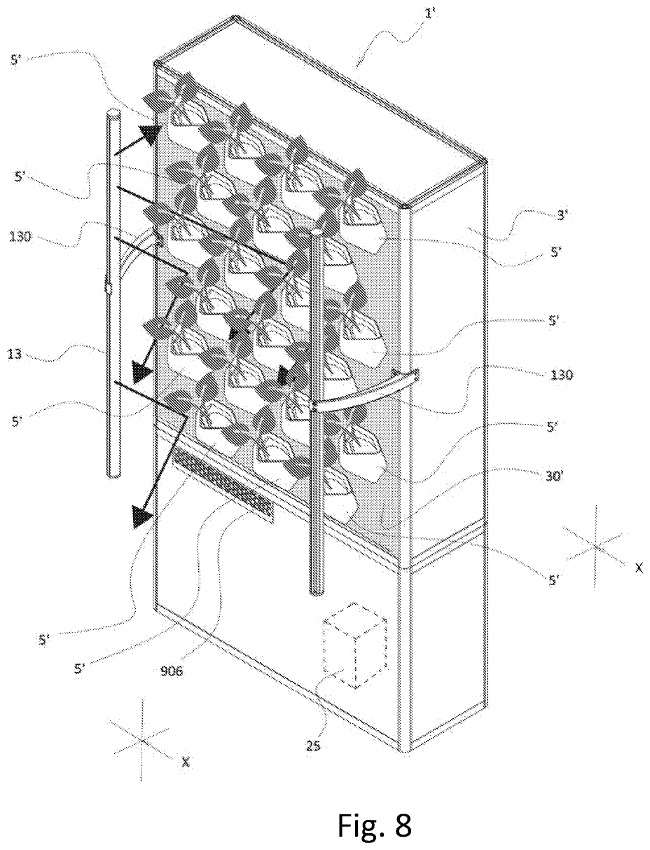

FIG. 8 shows a perspective view of a growing system according to a third particular embodiment of the present invention;

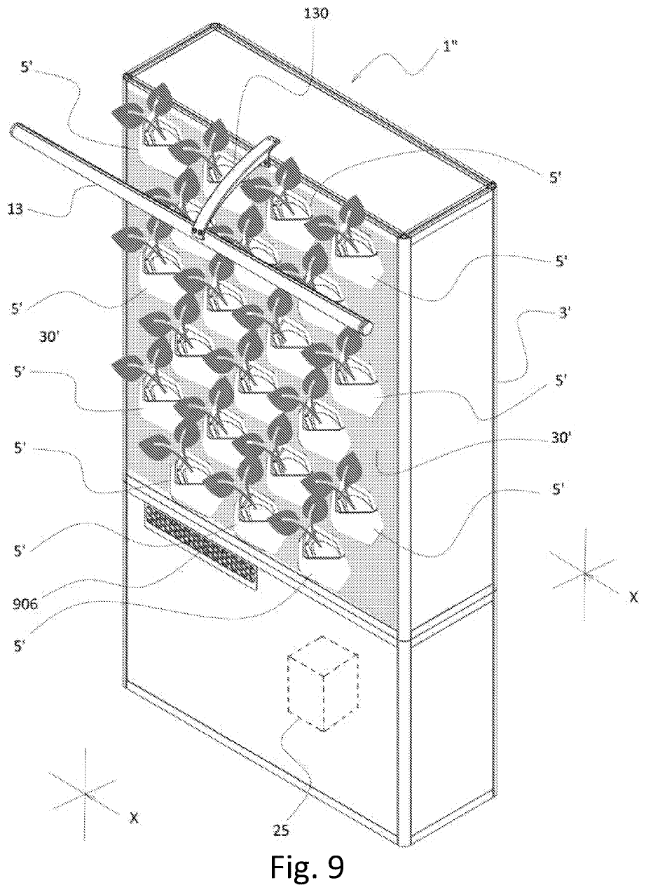

FIG. 9 shows a perspective view of a growing system according to a fourth particular embodiment of the present invention;

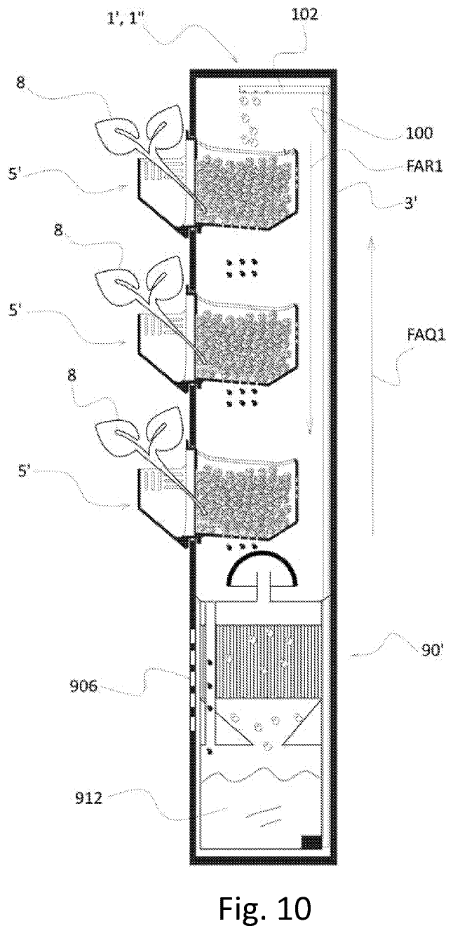

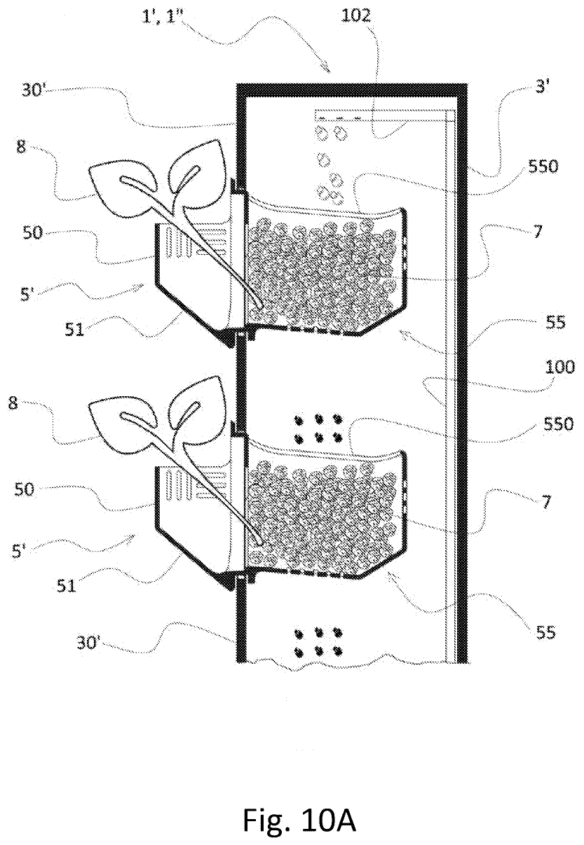

FIG. 10 shows a partially sectional view, according to section plane X-X, of the growing system of FIG. 9 or 10;

FIG. 10a shows an enlarged detail of FIG. 10;

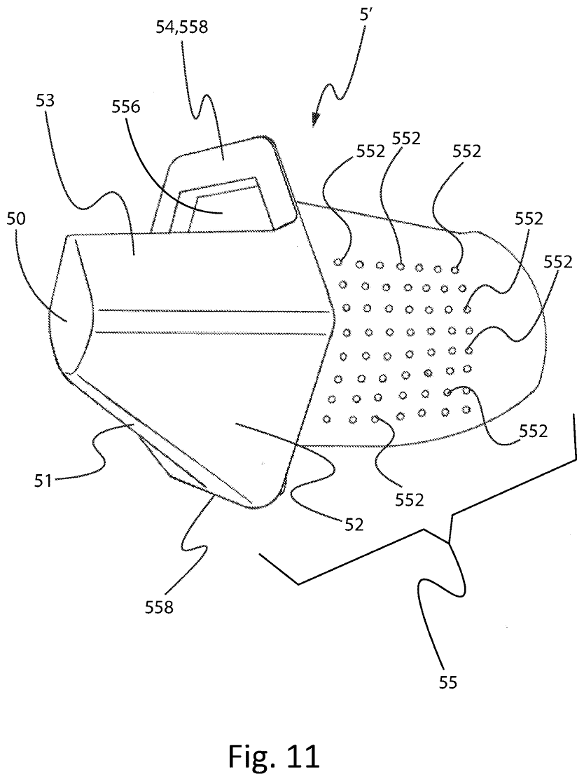

FIG. 11 shows a perspective view of a growing receptacle of the growing system of FIG. 9 or 10;

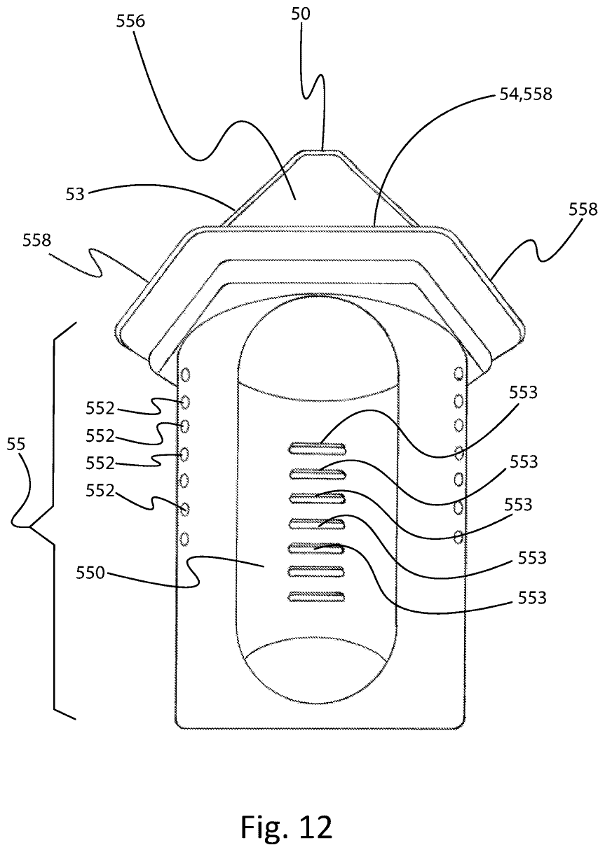

FIG. 12 shows a top view of the growing receptacle of FIG. 11;

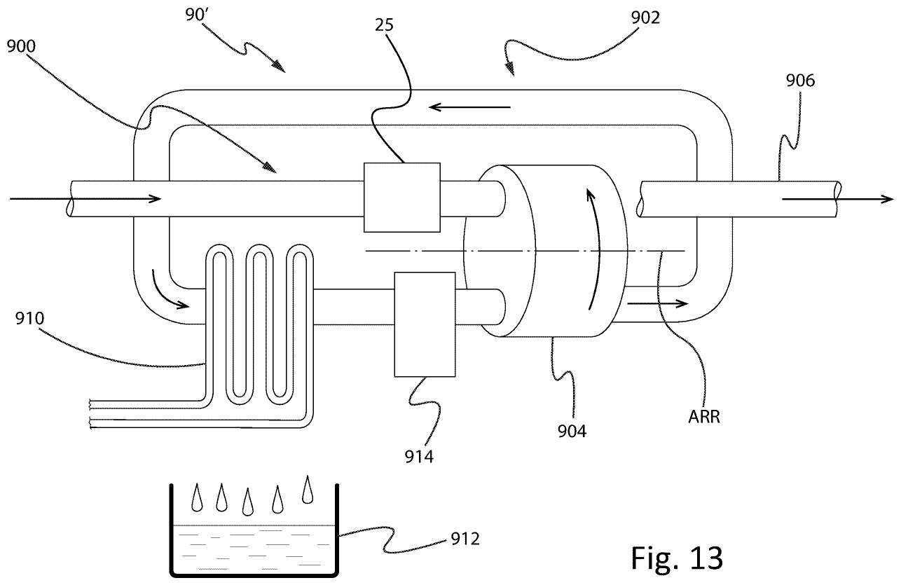

FIG. 13 shows a functional diagram of a water generator usable in the growing systems of FIGS. 1, 4, 8, 9;

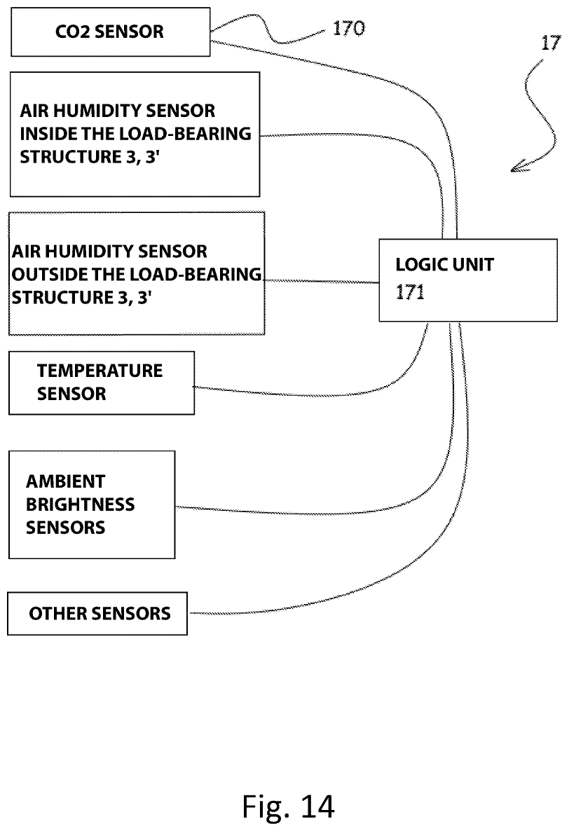

FIG. 14 shows a functional diagram of the control system of the growing system of FIG. 8 or 9 also usable in the growing system of FIG. 1 or 4.

### DETAILED DESCRIPTION

In the present description the terms “high, low, above, below” when not otherwise specified refer to the conditions of normal use of the growing system, i.e. to the indoor system for making green walls subject-matter of the present invention.

FIGS. 1-3, 5-7 relate to a growing system and process according to a particular embodiment of the invention.

The growing system, indicated by the overall reference 1, 1′, 1″, comprises:
a load-bearing structure 3, 3′ in turn comprising one or more growing receptacles 5, 5′, each one containing a growing medium 7 destined for containing, supporting and/or feeding the roots of at least one plant 8;
a feeding system 9 configured for providing water, fertilisers and/or other nutrients to the at least one plant, for example by introducing them into the growing medium 7 or by spraying them directly onto the roots or other parts of the plant 8;
a photostimulation system 11 comprising one or more light sources 13 capable of stimulating photosynthesis processes in the at least one plant 8 allowing its growth or at least survival;
a control system 17 configured for automatically controlling the feeding system 9 and/or the photostimulation system 11 based on the detection of one or more operating variables of one or more of the feeding system 9, the photostimulation system 11 and one or more physical/chemical quantities indicative of the vital conditions of the at least one plant 8.

Plant 8 in the present disclosure means any plant organism or group of plant organisms visible to the naked eye, such as, for example, a herbaceous plant, a shrub, a moss or a lichen formation, algae or algal formation, even microscopic ones.

According to one aspect of the invention, the growing system 1 comprises one or more photosynthesis reflectors, each of which comprises a reflective surface configured for reflecting—eventually concentrating—the light radiation emitted by the one or more light sources back to the portions of said at least one plant (8) wherein chlorophyll photosynthesis takes place—that is, for example back to the leaves of a herbaceous plant, shrub or moss or back to the portions of a lichen in which the cyanobacteria or the algae that make up a lichen are present.

For this purpose, said reflective surface configured for facing and/or being directed to the portions of said at least one plant (8) wherein chlorophyll photosynthesis takes place.

Again for this purpose said reflective surface has a total reflectance equal to or greater than 30% at least for a visible light.

The total reflectance comprises both specular reflection and diffuse reflection of the surface under consideration.

The total reflectance of the photosynthesis reflectors is preferably equal to or greater than 40%, and more preferably equal to or greater than 50%, 70%, 85%, 90%, 95% or 97%.

Preferably, the reflective surfaces of the photosynthesis reflectors form or otherwise extend over at least 20% of the total surface of the growing system 1 configured for facing and/or being directed to the portions of said at least one plant (8) wherein chlorophyll photosynthesis takes place.

The photosynthesis reflectors may comprise for example at least a portion of a growing receptacle 5′ or a panel 30′ supporting a plurality of growing receptacles 5′, each of which receptacles protrudes at least partially from the panel 30′ so that during normal use the latter is behind the protruding portion of the receptacle 5′ and behind the plant 8 grown in the receptacle 5′ in question (FIG. 8-10).

The photosynthesis reflectors preferably face and/or are configured for being directed to the environment intended to be decorated by the plants 8, or from which the plants 8 must be visible (FIG. 8-10).

A photosynthesis reflector may for example be an outer surface of a pot or other growing receptacle 5, 5′, such as for example one or more of the front surfaces 50, 51, 52, 53, 54 of the growing receptacle 5′ of FIGS. 11, 12.

More preferably, the reflective surfaces of the photosynthesis reflectors form or otherwise extend over at least 30%, and even more preferably over at least 40%, over 50%, over 60% or over 70% of the total surface of the growing system 1 configured for facing and/or being directed to the portions of said at least one plant (8) wherein chlorophyll photosynthesis takes place.

The above reflectance values are preferably referred to an electromagnetic radiation having wavelengths in the visible light band and/or between 400-700 nm (nanometres) or between 450-660 nm. More preferably, the reflective surfaces of the

photosynthesis reflectors have the above-mentioned reflectance values substantially for any light having a wavelength between 400-700 nm or between 450-660 nm, i.e. they have the previous reflectance values over the above-mentioned entire wavelength bands.

The reflective surfaces of the photosynthesis reflectors may be oriented vertically, horizontally or inclined for example at 30°, at 45° or at 60° with respect to a vertical plane perpendicular to and/or with respect to a vertical plane parallel to the front/rear direction of the growing system 1.

The reflective surfaces of the photosynthesis reflectors may be, for example, mirror surfaces.

During normal operation, the reflective surfaces 30′, 50-54 reflect back to the one or more plants 8 the light emitted by the one or more light sources 13 increasing the efficiency of the lighting of the plants and of their photosynthesis; the plants 8 in particular, with the same amount of electricity consumed by the light sources 13 receive more light and more uniformly; this reduces, among other things, the internodal distance of the plant, which has a thicker, more beautiful and more easily maintainable foliage.

The fertilisers that the feeding system 9 can provide can be, for example, chemical, natural fertilisers or soil improvers in solid, liquid or gel form; they can be, for example, supplied to the plant 8 in aqueous solution.

The growing medium 7 may be solid, liquid or gel, and comprise for example earth, soil, peat, manure, guano, sand, gravel, wadding or other fibrous materials, an aqueous solution.

Preferably the growing medium comprises one or more of the following materials: perlite, expanded clay, volcanic lapillus, pumice.

These materials offer a large internal bioavailable surface area for the exchange of bioavailable water and the establishment of colonies of “good” bacteria of the rhizosphere or similar—which, by occupying the biological niche, help prevent diseases—and of symbiotic fungi—e.g. mycorrhizae—that make plants stronger achieving a radical symbiosis.

The growing medium may further comprise zeolite—a soil improver that prevents many fungal diseases—and/or other functional soil improvers such as biochar or charcoal.

These materials, compared to the media usually used in hydroponic agriculture such as rock wool, coconut fibre, other vegetable fibres, offer the advantage of not biodegrading and therefore not having to be replaced with relative frequency, that is several times a year; they also lend themselves to being crossed by air, ventilating the growing medium and the roots of the plants growing therein well.

The perlite content is preferably between about 30-40% and for example equal to about 35%.

The content of expanded clay, volcanic lapillus or pumice is preferably between about 40-50% and for example equal to about 45%.

This composition is particularly advantageous because it allows a good passage of air without completely drying out the wet elements of the medium, it also allows a good water drainage and at the same time a good root fixation in the soil.

Each growing receptacle 5, 5′ can be made for example substantially as a box (FIGS. 1 and 2), a vase, a bowl, a dish, a more or less foldable pocket, a rack or shelf, a cavity, a recess.

Preferably the load-bearing structure 3, 3′ forms a plurality of growing receptacles 5, 5′ (FIGS. 1 and 2).

One or more of the artificial light sources 13 advantageously comprise an LED light emitting diode lamp.

Preferably the LED(s) is/are of the low power type.

Alternatively, one or more of the artificial light sources 13 may in any case comprise for example an incandescent, fluorescent, neon, discharge lamp, a halogen lamp, a lamp capable of emitting a light spectrum whose power associated with suitable frequencies for each mass kilogram of the at least one plant to be grown/kept alive in the growing system or through the growing system, an electrically powered lamp.

The photostimulation system 11 is configured for preferably providing at least half, and even more preferably at least 70%, 75%, 80%, 90%, 99% or all of the energy that the at least one plant needs, in a predetermined time interval, to implement its photosynthesis processes and grow or at least survive; this time interval can be for example one second, one minute, one hour, one day, one week, one quarter, one year or the entire life of the plant 8.

The at least one lamp 13 or more generally the photostimulation system 11 is configured for emitting an electromagnetic radiation with a wavelength preferably in the visible light band and/or between 400-700 nm (nanometres), and more preferably between 450-660 nm; the latter interval of wavelengths in fact comprises the so-called Photo-red spectrum, corresponding to about 660 nm, and the so-called Royal-blue spectrum, corresponding to 450 nm; the Photo-red and Royal-blue spectra correspond to two peaks of chlorophyll absorption and therefore of photosynthesis stimulation, wherein the Photo-red peak is more effective than the Royal-blue one.

Alternatively, the at least one lamp 13 or more generally the photostimulation system 11 is configured for emitting a substantially red electromagnetic radiation with a wavelength between about 600-700 nm, and/or a substantially blue electromagnetic radiation with a wavelength between about 400-500 nm.

In general, red light stimulates photosynthesis more effectively than blue light, but it is still preferable to stimulate plants 8 with spectra wider than that of red light.

The at least one lamp 13 or more generally the photostimulation system 11 can be possibly configured for emitting an electromagnetic radiation also in the near-infrared band, that is in the NIR, near-Infrared, that is with wavelengths between about 800-2500 nm, more effective than the only visible red light in the treatment of depression and in promoting mental well-being in general.

Advantageously, the at least one lamp 13 or more generally the photostimulation system 11 can be possibly configured for varying the colour temperature of their light emission over a period of 24 hours in order to mimic the cycles of natural light, colder in the morning and warmer in the afternoon and at sunset, for example to better prepare present people for relaxation or sleep—for this purpose yellow or orange toned lights are in fact particularly suitable.

More generally the at least one lamp 13 or more generally the photostimulation system 11 can be configured for varying the colour temperature—that is the tone of their light emission according to the needs of the users, allowing for example to choose cold and/or bluish tones to improve mood and efficiency or the aforementioned warm tones to relax.

Preferably the artificial light source 13 or the group of the sources 13 depending on whether the growing system has only one or a plurality, or more generally the photostimulation system 11 is configured for illuminating the plants 8 with a light radiation intensity equal to or greater than 400 lux, more preferably equal to or greater than 500 lux, more preferably equal to or greater than 4000 lux, and even more preferably between 5000-21000 lux, between 8000-12000 lux, between 9000-11000 lux and for example equal to about 10.000 lux so as to significantly stimulate the photosynthesis and the growth of the plants 8.

Preferably the artificial light source 13 or the thr group of the sources 13 depending on whether the growing system has only one or a plurality, or more generally the photostimulation system 11 is configured for illuminating the plants 8 with a light radiation capable of investing the at least one plant 8 that it is wished to grow/maintain alive through the growing system (1) with a photosynthetic photonic flux (PPF) preferably equal to or greater than 100 μmol/sqm (micromoles per square metre), more preferably equal to or greater than 150 μmol/sqm, 250 μmol/sqm, 450 μmol/sqm, wherein photosynthetic photonic flux means the photon density of the region PAR—that is in the frequency band 400-700 nm—which invests a square metre of surface.

The artificial light source 13 or the group of the sources 13 are configured for investing the at least one plant 8 with a photosynthetic photonic flux preferably equal to or less than 1000 μmol/sqm, more preferably equal to 800 μmol/sqm or to 750 μmol/sqm.

Advantageously, each artificial light source 13 has an overall and substantially oblong shape (FIG. 8, 9) and can be arranged for example vertically (FIG. 8) or horizontally (FIG. 9).

Advantageously, one or more artificial light sources 13 extend over the entire height of the distribution of the plants 8 and/or of the respective growing receptacles 5, 5′ (FIG. 8).

Advantageously, at least two artificial light sources 13 each extend along, near or at a respective vertical edge of the distribution of the plants 8 and/or of the respective growing receptacles 5, 5′, so as to more uniformly illuminate the plants 8 (FIG. 8).

Alternatively or in combination with the above, advantageously one or more artificial light sources 13 extend over the entire width, according to a horizontal direction, of the distribution of the plants 8 and/or of the respective growing receptacles 5, 5′ (FIG. 9).

In this case, preferably at least one artificial light source 13 extends along, at or near the upper edge or in any case the top of the distribution of the plants 8 and/or of the respective growing receptacles 5, 5′, so as to more closely simulate the direction of incidence of the sun's rays and encumber less in the underlying space accessible to the users (FIG. 9).

The artificial light sources 13 can be fixed to and supported by arms 130 which are either fixed (FIG. 8, 9) or possibly movable, for example hinged to the panel 3, 30′ or in any case to the rest of the load-bearing structure 3, 30′ so as to be able to rotate around an axis for example vertical or horizontal.

The arms 130 can be possibly moved and driven by suitable electric motors or other actuators in order to move the shadows of the plants 8 simulating, for example, the movement of leaves or branches in the wind or other relaxing or aesthetically pleasing effects.

Advantageously, the growing system 1, 1′, 1″ comprises a supply system 15 configured for supplying electromagnetic, thermal, chemical and/or mechanical energy to feeding 9 the system and/or the photostimulation system 11 allowing the operation thereof, and the supply system 15 comprises one or more of the following elements: a photovoltaic panel, a connection to an external public or local electricity distribution network, a wind or hydraulic energy generator such as for example a turbine for small waterways exploitation, a fuel cell, a bioreactor, a generator unit comprising in turn a dynamo or other electric power generator and an internal combustion engine which is configured for operating the electric power generator.

The supply system 15 is configured for providing at least one-third, and more preferably at least one-half, at least two-thirds, three-quarters, nine-tenths or all of the energy absorbed instantly or in a predetermined time interval by the feeding system 9 and/or by the photostimulation system 11 allowing the operation thereof; such predetermined time interval may be for example one second, one minute, one hour, one day, one week, one month, one trimester, one year or the entire life of the plant 8.

The control system 17 may comprise a logic unit 171 made for example as a PLC (Programmable Logic Controller), an electronic computer or more generally a microprocessor and preferably one or more sensors such as for example the following ones: a temperature sensor for the air, the growing medium 7 and/or any water provided by the feeding system 9 to the growing medium 7, an atmospheric humidity sensor, a humidity and/or pH sensor of the growing medium 7, a chemical sensor for detecting the presence of particular chemicals in the growing medium 7, an atmospheric carbon dioxide sensor 170, an ambient brightness sensor, a voltage or current sensor configured for detecting the voltage and/or the electric current at an internal point of the feeding system 9, of the photostimulation system 11 and/or of the supply system 15 (FIG. 14).

The control system 17 is advantageously programmed or in any case configured for controlling, for example, the artificial light source 13 or other element of the photostimulation system 11, the feeding system 9 and/or the supply system 15 based on the detections of one or more of the aforementioned sensors and/or of the commands given by an end user through a possible communication interface 19.

Such an interface 19 may comprise for example a wireless transceiver—for example with Wi-Fi, Bluetooth, Zigbee technology—and/or by cable.

Preferably the interface 19 is configured for communicating via telephone lines, internet or LAN or WAN telematic networks.

The growing system 1, 1′, 1″ is preferably configured for sending, for example via the communication interface 19, information about its status, alarm messages, reminders or other warnings to an end user.

For this purpose, the growing system may transmit such information and warnings to a possible smartphone, mobile phone, personal computer or other electronic device of the end user.

The load-bearing structure 3, 3′ is configured for supporting at least part of the aerial part of the at least one plant 8 forming for example one or more of the following substructures: a panel or other substantially vertical wall (FIG. 1, 2), a lattice, a mesh, grid or grate, a pole, a pergola, a trellis with possibly a lattice structure, a floor, a ceiling, a vault.

By “substantially vertical” unless otherwise specified in the present disclosure it is meant that the wall or other element has an inclination α [alpha] equal to or less than 45° with respect to a perfectly vertical direction DV (FIG. 6).

During normal use and operation, the panel or other load-bearing structure 3, 3′ may have a width WS in the horizontal direction and a height HS in the vertical direction preferably between 0,5-8 metres, or between 1-6 metres, 1-4 metres or 2-3 metres.

Advantageously, one or more—and preferably all—of the following elements are fixed to the panel or other load-bearing structure 3, 3′: the feeding system 9, the photostimulation system 11, the supply system 15, the control system 17, its logic unit 171 and/or at least part of its sensors, the communication interface 19.

In this way, the load-bearing structure 3, 3′ forms with the aforementioned elements a functionally complete and autonomous module capable of feeding and making the plant 8 or the plants 8 planted therein live.

Each of the feeding 9, photostimulation 11 and supply 15 systems can be fixed in whole or in part to a respective load-bearing structure 3, 3′: for example if the supply system 15 comprises a photovoltaic panel 150, a battery (accumulator, not shown) and an inverter or transformer 152, the battery, the inverter and/or the transformer 152 are preferably fixed to the load-bearing structure 3, 3′ which is preferably arranged in a closed room of a building, whereas the photovoltaic panel 150 can be placed outside the building.

The load-bearing structure 3, 3′ may in turn be formed by a plurality of modular modules 30, each of which may have the overall shape for example of a panel and form one or more growing receptacles 5, 5′ (FIG. 4).

The various modular modules 30 can be fixed together with each other for example by means of joints, quick couplings, dowels, screws or other threaded connections, glues, cements, welds.

Each growing receptacle 5, 5′ may be configured for accommodating at least part of the root apparatus of one or more plants 8, such as mosses, ferns, lichens.

More generally, the load-bearing structure 3, 3′ may be configured for containing at least in part and/or supporting at least part of the root apparatus and/or of the aerial portions of, for example, the plants 8 listed above.

Advantageously, the feeding system 9 comprises a water generator 90,90′ configured for obtaining liquid water from the atmospheric humidity (FIG. 5).

According to a first particular embodiment the water generator 90 may advantageously comprise at least one Peltier cell in turn comprising a hot plate and a cold plate (not shown).

The water generator 90 is advantageously configured for condensing the atmospheric humidity on the cold plate and/or on a humidity condenser cooled by the cold plate.

For this purpose, the control system 17 or more generally the growing system 1, 1′, 1″ is programmed or in any case configured for maintaining the temperature of the cold plate and/or of the humidity condenser at a temperature equal to or lower than the dew temperature of the air that surround them.

The water generator 9 may further comprise a metering unit 92 configured for delivering the water produced by the water generator 90 at the desired times and in the desired quantities to the one or more plants 8.

The growing system 1, 1′ is preferably configured for irrigating the plants 8 by dripping from above, more preferably by dripping or otherwise dropping the irrigation water and any nutrients dissolved therein and not from one or more growing receptacles 5, 5′ into one or more other growing receptacles 5, 5′ below (FIG. 8).

To this end, each growing receptacle 5′ comprises an irrigation portion 55 configured for collecting the irrigation water dripping from above and/or for dripping the irrigation water downwards (FIG. 11, 12).

The irrigation portion 55 is preferably arranged within the load-bearing structure 3, 3′, for example behind the panel 30′ from which the growing receptacles 5′ protrude (FIG. 8, 8A).

Any reflective surfaces 50, 51, 52, 53, 54 of the growing receptacle 5′ are preferably arranged outside the load-bearing structure 3, 3′, for example in front, behind the panel 30′ from which the growing receptacles 5′ protrude (FIG. 8, 8A).

For this purpose, the front side of each growing receptacle can have, for example, substantially the shape of a beak, cusp, back, pyramid or pyramid trunk (FIG. 11, 12).

The growing receptacles 5′ can each be provided with a rest flange 558 configured for resting against the edge of the possible opening of the panel 30′ through which the irrigation portion 55 can be inserted (FIG. 11, 12).

Advantageously, the growing receptacles 5′ may each form a suction port 556 configured for functioning as an air intake that allows the air of the outside environment to be drawn in into the load-bearing structure 3, 3′, as will be explained further below (FIG. 11, 12).

The port 556 can be formed for example inside the rest flange 558 and/or at or near the beak, cusp, back, pyramid or pyramid trunk or other front portion of the receptacle 5′ intended to protrude outside the panel 30′.

To this end, such a beak, cusp, back, pyramid or pyramid trunk or other protruding front portion of the receptacle 5′ may advantageously be opened upwards (FIG. 12).

The irrigation portion 55 advantageously forms an internal cavity configured for containing a bed of growing medium 7 and an upper opening 550 that put the internal cavity in fluidic communication with the outside environment.

The upper opening 550 is preferably configured for collecting the water that drips or otherwise falls from above (FIG. 8, 8A).

The irrigation portion 55 is advantageously provided with a plurality of holes or other drainage openings 552 configured for letting the water and other nutrients leaking downwards into the growing medium 7 to flow out and fall downwards.

The holes or other drainage openings may form, for example, a grid or a grate.

On the bottom of the irrigation portion 55 there may be drainage holes 552 and/or a plurality of drainage slots 553, oriented for example transversely to the irrigation portion 55 as a whole, this if is substantially oblong, and/or parallel or longitudinally to the panel 30′ and/or to the rest flange 558 (FIG. 12).

Advantageously, the various growing receptacles 5′ are arranged in one or more columns, substantially vertical, the ones on top of the others so that the water and other nutrients that flow out of the holes or other drainage openings 552 of a growing receptacle 5′ fall into a growing receptacle 5′ below (FIG. 8, 8A).

Advantageously, the various growing receptacles 5′ are arranged so as to interpose an appropriate vertical distance—for example equal to 1-3 times the maximum vertical encumbrance of a receptacle 5′—between two adjacent receptacles 5′ and allow the water falling therefrom—for example through the drainage openings 552—to moisten the air inside the load-bearing structure 3, 3′.

According to a first particular embodiment the water generator 90′ may advantageously comprise an adsorption dehumidifier, of the type for example described in patent applications EP0360752A2, U.S. Pat. Nos. 4,887,438, 5,242,473, 5,512,083 or in Japanese published utility model application no. JP62-148330U.

Such a type of dehumidifier or dryer comprises a first path of the air to be treated 900, a second regeneration air path 902, a drying rotor 904 (FIG. 13).

The drying rotor 904 contains an adsorbent material and is configured for reversibly switching from a first drying position to a second regeneration position.

In the first drying position the drying rotor 904 is configured for trapping by adsorption in the adsorbent material the humidity of the air provided by the first path of the air to be treated.

In the second regeneration position the drying rotor 904 is configured for releasing by desorption the adsorbed humidity into the adsorbent material.

The adsorbent material can be, for example, silica gel or other material capable of adsorbing and fixing the humidity of the ambient air in its inside.

The air to be treated coming from the outside environment travelling along the first path 900 can reach the drying rotor 904 which traps in its inside at least part—preferably most—of the humidity of this air, which flows out the delivery port 906 drier, which is advantageously located in the bottom part of the load-bearing structure 3, 3′ (FIG. 8, 9, 10, 13).

Periodically, the drying rotor 904 can be regenerated by rotating it around an axis of rotation ARR at a suitable angle so as to carry a portion thereof rich in water—or in humidity—extracted from the atmosphere at a regeneration zone 908 where it is invested by a flow of heated regeneration air, for example by a heating element 914 such as for example an electric resistor or a heat exchanger.

The regeneration air causes the silica gel or other adsorbent material to release the water that had been adsorbed into the regeneration air itself.

The hottest and wettest regeneration air by travelling along the second path 902 can reach for example a suitable condenser 910—for example the coil of a compressor refrigeration circuit or of other type—where it is cooled.

Due to cooling the humidity contained in the regeneration air condenses for example in the collection tank 912, from which it can be periodically evacuated.

The adsorption dehumidifiers or dryers allow the extraction of water from air that has an already relatively low relative humidity percentage, for example around 35-40%, which is often the case of the air in offices and other environments where the usual air conditioning systems are present; they also allow the extraction of water from relatively cold air, that is, only a few degrees above zero Celsius, noiselessly, with efficiency and energy savings.

The water generator 90′ is preferably arranged in the base or in the lowest part or in a bottom part of the load-bearing structure 3, 3′ (FIG. 8). The growing system 1, 1′, 1″ is advantageously provided with at least one irrigation conduit 100 configured for transferring the water produced by the water generator 90′ as far as suitable irrigation points 102 which are preferably located above a respective irrigation portion 55 of a growing receptacle 5′, more preferably above the irrigation portion 55 of the growing receptacle 5′ above which no other one is present (FIG. 10, 10A).

Advantageously, the growing system 1, 1′, 1′ is provided with at least one fan 25 or other pneumatic vacuum generator configured for producing a pneumatic vacuum inside the load-bearing structure 3, 3′ preferably by drawing in air from the outside towards the inside of the load-bearing structure 3, 3′.

To this end, the fan 25 or other pneumatic vacuum generator is preferably arranged within the load-bearing structure 3, 3′, more preferably in the base or in any case in the lower part of the structure 3, 3′, for example lower down than the growing receptacles 5, 5′ (FIG. 8, 9).

The fan 25 can be possibly the fan inside the adsorption water generator 90′ that blows the air from the first path of the air to be treated 900 towards the drying rotor 904 (FIG. 13).

Advantageously, the fan 25 or other pneumatic vacuum generator is configured for drawing in air from the outside towards the inside of the load-bearing structure 3, 3′ through the openings 556 formed by the various growing receptacles 5′ and through the bed of growing medium 7 contained therein.

The growing system 1, 1′, 1″ may then function, for example and preferably, as follows.

A pump or other pumping device not shown withdraws the water collected in the tank 912 and sends it upwards (arrow FAQ1) as far as an irrigation point 102 located above a growing receptacle 5′ in turn preferably arranged at the top of a column of growing receptacles 5′ (FIG. 10, 10A).

The irrigation point 102 causes the irrigation water to drip or otherwise fall into the growing receptacle 5′ at the top of the column, for example in the upper opening thereof 550, wetting or otherwise moistening the growing medium 7 and irrigating the plant 8 contained in the receptacle 5′.

Part of the water present in the receptacle 5′ at the top of the column outflows through the drainage openings 552 and falls, for example, into the growing receptacle 5′ immediately below, for example in the penultimate receptacle 5′ at the top of the receptacle column 5′, irrigating and feeding the relevant plant 8. The previous drop irrigation cycle is preferably

repeated in cascade for all possible receptacles below the penultimate receptacle 5′, until some of the irrigation water is collected in the underlying collection tank 912.

Preferably at the same time the fan 25 can draw in air from the outside environment inside the system 1, 1′ through the ports 556 formed by the growing receptacles 5′ downwards (arrow FAR1), so as to dampen the air with the humidity of the growing media 7 which is contained in the various growing receptacles 5, 5′ and/or the water dripping from one receptacle 5, 5′ to the other.

In particular, the ambient air by passing through the growing medium 7 is humidified and cools down.

The ports 556 of the growing receptacles 5′ force much of the draw in air to pass through the respective beds of growing medium 7 increasing the ventilation and the humidification of the draw in air.

The growing medium 7 can be crossed by the air flow with relative ease also thanks to its particular composition described above; this composition on the other hand allows the medium 7 to retain in its inside a good percentage of humidity and/or of water avoiding excessively drying itself and hence also the roots of the plants 8 that grow therein.

Through the growing medium 7 the ambient air is also purified from pollutants.

Preferably the air intake is located at the front of the load-bearing structure 3, 3′ or more generally of the system 1, 1′, 1″.

The ambient air drawn in from a higher elevation is warmer and richer in humidity and increases the efficiency of the water generator 90, 90′.

The fan preferably and in any case directs the air withdrawn from the outside environment towards the water generator 90, 90′ which, as has already been partially exposed, extracts the water from the humidity of the incoming air and accumulates it in the collection tank 912, from which it can be pumped again or in any case sent back to the one or more irrigation points 102.

When the atmospheric carbon dioxide sensor(s) 170 detect(s) a carbon dioxide level equal to or greater than a first predetermined threshold, the control system 17 is advantageously programmed or otherwise configured for activating the photostimulation system 11 and the feeding system 9 if they are switched off, and for increasing their activity if they are already active, for example by switching on or otherwise increasing the light power emitted by the one or more light sources 13 and activating or otherwise increasing the irrigation by the one or more irrigation points 102 or more generally by the feeding system 9.

The plants 8 are therefore more illuminated by the one or more light sources 13 and more irrigated and possibly also supplied with nutrients.

Increased photostimulation and irrigation accelerate plant photosynthesis 8 and thus the conversion of ambient carbon dioxide into oxygen, purifying the environment.

Advantageously, the control system 17 is advantageously programmed or in any case configured for activating the aforementioned fan when the atmospheric carbon dioxide sensor(s) 170 detect(s) a carbon dioxide level equal to or greater than a first predetermined threshold, which may possibly coincide with the first predetermined threshold.

This avoids activating ventilation only based on user perception, reducing electricity and heat waste caused by unnecessary ventilation, for example by opening windows and doors.

A possible example of operation and of use of the growing system 1, 1′, 1″ is now described.

The load-bearing structure 3, 3′ is installed at the destination place, for example in a house, office, underground or railway station, hospital, factory, business centre or other environment, for example by assembling together one or more modular modules 30; the load-bearing structure 3, 3′ can be arranged for example in a room 21 of the building, for example so as to cover or in any case hide at least partially a wall thereof 23 (FIG. 7).

Any photovoltaic panel 150 can be installed, for example, outside the building inside which the load-bearing structure 3, 3′ is installed and then connected to the rest of the supply system 15 so as to supply it.

One or more plants 8 can then be buried or in any case planted in a respective growing receptacle 7, fed or otherwise supplied with water, fertilisers and other nutrients from the feeding system 9, irradiated with the appropriate light from the artificial light source 13 or more generally from the photostimulation system 11 and then allowed to grow or in any case kept alive.

Alternatively, seeds or spores from which one or more plants 8 grow may be sown in the growing receptacles 7.

The entire system 1, 1′, 1″ and the mode of use thereof may be such that at least part of the aerial part of each plant 8 will rest on the load-bearing structure 3, 3′, for example by having the trunk, stem and/or branches rest on it.

For example, the control system 17 can monitor the environmental conditions in which the plant(s) 8 grow(s) or live(s), trying to make them as optimal as possible by automatically controlling the operation of the supply 15, feeding 9 and photostimulation 11 systems, in particular trying to provide each plant 8 with water, light and nutrients in an optimal way.

The automatic management of the control system 17 greatly facilitates and alleviates work—particularly manual work—time and the knowledge and skills required of an end user or an attendant to care for the plants 8 and for the maintenance of the system 1, 1′, 1″, making it more cost-effective to install it widely in many enclosed environments by beautifying them, making them much healthier and bringing to their frequenters both physical and psychological benefits—including a greater productivity, concentration and creativity in work activities, a marked improvement in mood and psycho-physical well-being, a better functioning of the immune system—described above.

The control system 17 also allows to reduce and in any case optimize the energy and environmental resource needs—such as water, fertilisers and nutrients—necessary to sustain the plants 8, thus benefiting the environment in general and the global ecosystem.

The load-bearing structure 3, 3′ and many other components of the growing system 1, 1′, 1″ lend themselves to being obtained from environmentally sustainable, low environmental impact and low carbon footprint materials, helping companies and society in general to move towards a circular economy; this is particularly helped by the power supply through the photovoltaic panel 150 or other renewable energy sources.

The possible Peltier cell water generator 90 and the high-efficiency LEDs of the lamp 13 also contribute to reducing energy consumption, the production of greenhouse gases and more generally the pollution produced by the growing system 1, 1′, 1″.

The embodiments described above are susceptible to numerous modifications and variants, without departing from the scope of the present invention.

For example, the reflective surfaces of the photosynthesis reflectors can be obtained not only on the panel 30′ or on the growing receptacles 5′ but also on other protrusions of the panel 30′ or other protrusions of a substantially vertical wall or curtain formed by the growing system 1, 1′, 1″.

A growing system, that is an indoor system according to the present invention can be provided with one or more delivery ports 906 located in the bottom part of the load-bearing structure 3, 3′ even when the water generator is absent or is present but is not of the adsorption type.

In particular embodiments the logic unit of the control system 17 may be partially or completely remote, for example consisting of or comprising a server computer connected in the cloud to the system 1, 1′, 1″, or may further comprise a first logic subunit mounted on board the support 3, 3′ or more generally the system 1, 1′, 1″ and a second logic subunit comprising a remote server computer.

According to a further aspect thereof the present invention relates to a green wall in turn comprising an indoor system for making self-sufficient green walls (1, 1′, 1″) and at least one plant (8), wherein green wall:
the indoor system (1, 1′, 1″) comprises:
   a) a load-bearing structure (3, 3′) in turn comprising one or more growing receptacles (5, 5′), each one containing a growing medium (7) destined for containing, supporting and/or feeding the roots of at least one plant (8);
   b) a feeding system (9, 9′) configured for providing water, fertilisers and/or other nutrients to the at least one plant;
   c) a photostimulation system (11) comprising one or more light sources (13) capable of stimulating photosynthesis processes in said at least one plant;
   d) a control system (17) configured for automatically controlling the feeding system (9, 9′) and/or the photostimulation system (11) based on the detection of one or more operating variables of one or more of the feeding system (9, 9′), the photostimulation system (11) and one or more physical/chemical quantities of the at least one plant (8) and/or the environment surrounding it;
the at least one plant (8) is planted in one or more of the growing receptacles (5, 5′).

According to a further aspect thereof the present invention relates to an indoor system for making self-sufficient green walls (1, 1′, 1″) comprising:
a load-bearing structure (3, 3′) in turn comprising one or more growing receptacles (5, 5′), each one containing a growing medium (7) destined for containing, supporting and/or feeding the roots of at least one plant (8);
a feeding system (9, 9′) configured for providing water, fertilisers and/or other nutrients to the at least one plant;
a photostimulation system (11) comprising one or more light sources (13) capable of stimulating photosynthesis processes in said at least one plant;
a control system (17) configured for automatically controlling the feeding system (9, 9′) and/or the photostimulation system (11) based on the detection of one or more operating variables of one or more of the feeding system (9, 9′), the photostimulation system (11) and one or more physical/chemical quantities of the at least one plant (8) and/or the environment surrounding it.

The examples and lists of possible variants of the present application are to be construed as non-exhaustive lists.

1. An indoor system for making self-sufficient green walls, the indoor system comprising:
a load-bearing structure comprising one or more growing receptacles, wherein each of the one or more growing receptacles comprises a growing medium configured to contain, support, and/or feed roots of at least one plant;
a feeding system configured to provide water, fertilizers, and/or other nutrients to the at least one plant;
a photostimulation system comprising one or more light sources configured to stimulate photosynthesis processes in the at least one plant; and
a control system configured to automatically control the feeding system and/or the photostimulation system based on detection of one or more operating variables of one or more of the feeding system, the photostimulation system, and one or more physical/chemical quantities of the at least one plant and/or an environment surrounding the at least one plant.

2. The indoor system of claim 1, further comprising one or more photosynthesis reflectors, each of which comprises at least one reflective surface configured to reflect light radiation emitted by the one or more light sources back to portions of the at least one plant wherein chlorophyll photosynthesis takes place.

3. The indoor system of claim 2, wherein the at least one reflective surface has a total reflectance or greater than or equal to 40%.

4. The indoor system of claim 3, wherein a value of the total reflectance refers to any of the light radiation whose wavelength is greater than or equal to 450 nanometers (nm) and less than or equal to 660 nm.

5. The indoor system of claim 2, wherein reflective surfaces of the one or more photosynthesis reflectors extend over at least 30% of surfaces of the indoor system configured to face and/or to reflect light to the portions of the at least one plant wherein the chlorophyll photosynthesis takes place.

6. The indoor system of claim 1, wherein the one or more growing receptacles each forms a suction port, and
wherein the indoor system is configured to draw in air from an outside environment through the suction port.

7. The indoor system of claim 1, wherein the feeding system comprises a water generator, configured to obtain liquid water from atmospheric humidity, and at least one irrigation point, configured for irrigating to irrigate the at least one plant by dropping water into a growing receptacle of the one or more growing receptacles containing the roots of the at least one plant, and
wherein the at least one irrigation point is higher than the water generator.

8. The indoor system of claim 7, further comprising a plurality of the growing receptacles, wherein each of the growing receptacles contains at least a portion of a respective plant,
wherein the growing receptacles are configured one on top of the other so that water flowing from a higher one of the growing receptacles falls into a lower one of the growing receptacles, and
wherein the at least one irrigation point is configured so that water from the at least one irrigation point falls into at least one of the growing receptacles.

9. The indoor system of claim 7, further comprising a plurality of the growing receptacles at different heights,
wherein the water generator is lower than one or more and possibly of all of the growing receptacles, and
wherein the indoor system is configured to create an air flow lapping the growing receptacles, flowing top downwards to the water generator.

10. The indoor system of claim 1, further comprising a carbon dioxide sensor configured to detect atmospheric carbon dioxide present in the environment surrounding the at least one plant.

11. The indoor system of claim 1, wherein the feeding system comprises a water generator of an adsorption type configured obtain liquid water from atmospheric humidity and, in turn, comprising a first path of air to be treated, a second regeneration air path, and a drying rotor,
wherein the drying rotor contains adsorbent material and is configured to reversibly switch from a first drying position to a second regeneration position,
wherein in the first drying position, the drying rotor is configured to trap, by adsorption in the adsorbent material, humidity of the air provided by the first path of the air to be treated, and
wherein in the second regeneration position, the drying rotor is configured to release the adsorbed humidity from the adsorbent material by desorption.

12. The indoor system of claim 1, wherein the one or more light sources are further configured to emit electromagnetic radiation in one of the following wavelength ranges:
greater than or equal to 400 nanometers (nm) and less than or equal to 500 nm;
greater than or equal to 430 nm and less than or equal to 470 nm;
greater than or equal to 440 nm and less than or equal to 460 nm;
greater than or equal to 600 nm and less than or equal to 700 nm;
greater than or equal to 640 nm and less than or equal to 680 nm; and
greater than or equal to 650 nm and less than or equal to 670 nm. 13. A green wall, comprising:
the indoor system of claim 1; and
the at least one plant planted in the one or more growing receptacles.

14. A building, comprising:
the indoor system of claim 1; and
the at least one plant that covers, at least in part, the load-bearing structure.

15. A process for growing the at least one plant of claim 1, the process comprising:
growing or otherwise keeping alive the at least one plant at least partially supported by the load-bearing structure so that the at least one plant forms one or more of the following entities: a substantially vertical panel, a substantially vertical wall or other curtain, and a row.

16. The indoor system of claim 7, further comprising a plurality of the growing receptacles at different heights, wherein the water generator is lower than all of the growing receptacles, and wherein the indoor system is configured to create an air flow lapping the growing receptacles, flowing top downwards to the water generator.

17. The indoor system of claim 1, wherein the one or more light sources are further configured to emit electromagnetic radiation in the following wavelength range:
greater than or equal to 400 nanometers (nm) and less than or equal to 700 nm.

18. The indoor system of claim 1, wherein the one or more light sources are further configured to emit electromagnetic radiation in the following wavelength range:
greater than or equal to 430 nanometers (nm) and less than or equal to 680 nm.

19. The indoor system of claim 1, wherein the one or more light sources are further configured to emit electromagnetic radiation in the following wavelength range:
greater than or equal to 440 nanometers (nm) and less than or equal to 670 nm.

20. The indoor system of claim 1, wherein the one or more light sources are further configured to emit electromagnetic radiation in the following wavelength range:
greater than or equal to about 800 nanometers (nm) and less than or equal to about 2,500 nm.
